(19) United States
(12) Patent Application Publication
(10) Pub. No.: US 2011/0012384 A1
(43) Pub. Date: Jan. 20, 2011

(54) Vehicle and method for mobile hair care center

(76) Inventor: Josh L. Stewart, Fayetteville, GA (US)

Correspondence Address: J.T. HOLLIN, ATTORNEY AT LAW, PC, 110 HABERSHAM DRIVE, SUITE 144, FAYETTEVILLE, GA, 30214, US

(21) Appl. No.: 12/460,275

(22) Filed: Jul. 16, 2009

(51) Int. Cl. B60P 3/14

(52) U.S. Cl. 296/24.32

(57) ABSTRACT

Disclosed is a wheeled motorized vehicle designed and licensed to operate on public roads and specially equipped and furnished for the providing of hair and personal grooming services to male and/or female customers. The vehicle may be dispatched to a customer's location as a result of an individual on-demand basis, or the vehicle and its crew of professional grooming personnel may provide services to a plurality of persons at a specific entertainment or sports venue, or as contracted with in association with a business or academic institution. Also disclosed is a method for utilizing a plurality of the said vehicles in the business of a nationwide network of standardized mobile grooming services, via franchise opportunities. Franchisees enter into a franchise/license agreement to operate similarly-equipped vehicle(s) in various locations, provided that franchisees are experienced and qualified in the hair and/or personal grooming industry.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### REFERENCE TO A “SEQUENCE LISTING,” A TABLE, OR A COMPUTER PROGRAM LISTING APPENDIX

Not applicable.

### BACKGROUND OF THE INVENTION

(1) Field of the Invention

The inventive concept presented herein generally relates to the mobilization of services traditionally performed within the confines of a fixed location, i.e., a building, tent, or trailer. In particular, this concept relates to the providing of hair care and grooming services for men, women, and children inside a customized recreational-style vehicle. The vehicle has been adequately equipped and furnished, and is transportable to any prospective customer's location on short notice. A plurality of vehicles is provided in a myriad of geographic locations, rural or urban, with operators of the vehicles properly licensed and working within standardized grooming guidelines required by a business franchise center.

(2) Description of the Related Art

Many business and personal services are provided by mobile, specially-equipped vehicles. First in mind are hospital vans that are self contained with medical supplies, surgical equipment, and basic diagnostic machines. A minimum staffing is maintained within the vehicle to perform the medical examinations or procedures for which the vehicle is dispatched.

There have been several business operations traditionally performed from defined locations, primarily buildings, that have expanded the availability of their products or services by means of motorized vehicles. Whether out of necessity, or the choice of a means to expand the business or service to consumers, several examples of vehicular mobility can be found.

In U.S. Pat. No. 3,583,368 (1971) is presented a Mobile Animal Grooming Saloon, basically a large-sized motor van equipped with animal grooming equipment, including a bath basin, a drying station, and a variety of animal grooming accessories.

The military services have, during past years, operated mobile surgical hospitals in combat zones. By comparison, the inventor in U.S. Pat. No. 4,915,435 (1990), discloses a mobile operating room in a transportable vehicle in which invasive surgical procedures can be performed. The mobile vehicle is a self-contained expandable van equipped with all of the operating requirements found in fixed hospital facilities.

A German invention, disclosed in publication number DE19507944 (1996), presents a mobile van which houses a hairdresser's salon, hairdresser's working positions, a wash basin, customer waiting area, and handicap access provisions.

A Mobile Design and Fabrication Studio is presented in U.S. Pat. No. 6,969,102, (2004), The motor vehicle is transportable to a customer's site for the purpose of designing and custom fabricating prototypical corrugated paperboard products, such as POP displays and packaging.

US Patent Application Publication #2002/0135193 describes a Mobile Chiropractic Vehicle containing a patient waiting area with seats, separated by a room divider, from a room providing examining, diagnostic, and adjustment services to patients.

There are numerous examples of private, single-vehicle operations of mobile barber shops around various cities in the United States, however, as of this writing, none of these types of businesses have expanded into multiple units operating under unified or standardized procedures and grooming equipment guidelines. These enterprises function on a limited basis, and primarily in a particular neighborhood or municipality. There is no existing prior art indicating the expansive scale and scope of the inventive concept presented herein.

In this light, some typical examples include Onsite Haircuts, described as a “state-of-the-art mobile hair salon” in business for offering of barbering services in the parking lot of medium to large-sized businesses in the vicinity of San Jose, Calif.

Boost Mobile Jordan Classic Barber Shop, was a short-term business entity operated in conjunction with the 2006 Michael Jordan high school All-American basketball classic in New York City. The operators providing barbering services operated from an Airstream trailer located in an area near the Classic events.

The All American Cuts Barber Shop claims to be “the only mobile barber shop in California.” Operated out of a trailer near Castaic, Calif., the mobile barber shop features a red, white, and blue décor and attracts truckers who pass through while traveling on nearby U.S. Interstate 5.

Near Atlanta, Georgia, Creative Connections Mobile Barbershop offers barbering and salon services to a variety of senior citizen residences. While not a true mobile grooming facility the owners do use a van to transport their equipment, grooming products, and other accessories to the different locations where their prospective customers reside.

### BRIEF SUMMARY OF THE INVENTIVE CONCEPT

The inventive concept presented herein generally is concerned with a motor vehicle which is custom-equipped for providing on-demand, personal hair grooming services while parked at any of a plurality of varied locations. The concept further establishes a business method wherein the said personal grooming services can be standardized and franchised for a nation-wide customer service concept. The vehicle utilized may be a conversion of either a Class C or Class A motor home of the approximate configuration of an upscale recreational vehicle (RV).

For the convenience of referring to the disclosed concept, the recreational vehicles will be referred to in this application as a Mobile Grooming Vehicle, or MGV. The MGV is custom equipped with professional barber chairs, hair stylists' chairs, shampoo stations, hair dryer, sanitary cleaning sink, a waiting room, and a unisex toilet facility. As optional accessories, a beverage and food service counter, wireless laptop operating environment, LCD televisions, and other amenities may be included. All MGV's will be operated by licensed hair grooming professionals who are also franchise owner/operators.

### BRIEF DESCRIPTION OF THE VIEWS OF THE DRAWINGS

The objects, features, and advantages of the concept presented in this application are more readily understood when referring to the accompanying drawings. The drawings, totaling six figures, show the basic functions of various embodiments and methods. In the several figures, like reference numbers are used in each figure to correspond to the same component as may be depicted in other figures.

FIG. 1 shows a rendering of the exterior profile of a typical Class A recreational vehicle utilized in the “multiple service” MGV embodiment of the inventive concept.

FIG. 2 depicts a typical floor plan of the multiple-purpose MGV, including arrangement of the equipment and furnishings necessary for the business profile.

FIG. 3 sets forth the flow charts for four varied business profiles which determine the transport and positioning of the MGV for customer service.

FIG. 4 indicates the offered services available in the mobile RV, as standardized for national marketing media and quality control.

FIG. 5 presents a flow chart for granting of franchise licenses to persons seeking to operate a business under the auspices of the inventive concept.

FIG. 5A depicts a typical schedule of fees applicable to the franchised business.

FIG. 6 illustrates the floor plan of a Class C motor coach, which may be utilized by a start-up franchisee or in a very limited consumer marketing environment.

Nomenclature For Invention Components

| | |
|---|---|
| 1. | Mobile Grooming Vehicle |
| 2. | Vehicle entry |
| 3. | Lounge area |
| 4. | Customer seating |
| 5. | First barber chair |
| 6. | Second barber chair |
| 7. | First stylist's chair |
| 8. | Second stylist's chair |
| 9. | Shampoo station |
| 10. | First hair dryer |
| 11. | Second hair dryer |
| 12. | Sanitizing sink |
| 13. | Equipment cabinet |
| 14. | Product storage cabinet |
| 15. | Linens storage |
| 16. | First television |
| 17. | Second television |
| 18. | Drivers's seat |
| 19. | Passenger seat |
| 20. | Snack bar |
| 21. | Manicurist station |
| 22. | Mirror |
| 23. | Janitorial storage |
| 24. | Unisex lavatory |
| 25. | Emergency exit |
| 26. | Exterior customer seating |
| 27. | Profile “A” business operations |
| 28. | Profile “B” business operations |
| 29. | Profile “C” business operations |
| 30. | Profile “D” business operations |
| 31. | Fresh water tank |
| 32. | Grey and black water tanks |
| 33. | Class C motor coach |
| 34. | Class A Multiple-service MGV |
| 35. | Original franchisor |
| 36. | MGV Manufacturer |
| 37. | Franchisee selection guidelines |
| 38. | Franchise agreement |
| 39. | Master franchisor (typ.) |

### DETAILED DESCRIPTION OF THE INVENTIVE CONCEPT

The innovative business method and vehicles disclosed herein are intended to provide a nationwide standard of mobile hair grooming services. The specialized vehicles, referred to as Mobile Grooming Vehicles (MGV) are manufactured with furnishings and equipment conducive to providing quality barbering and grooming services care for men, and in the larger-sized MGV's, shampoo, styling, and other hair care services for women.

An important key to development of the franchise opportunities associated with this inventive concept is the structuring of a production contract with at least one manufacturer of RV's. Such a production contract provides that the manufacturer customize the interior of a selected recreational vehicle (RV) model. The production contract is predicated on acquiring newly manufactured RV's during the middle stages of assembly at the factory. Equipment, furnishings, and accessories required for performance of professional grooming services are then installed in accordance with a standardized layout formulated by engineers employed by the franchisor.

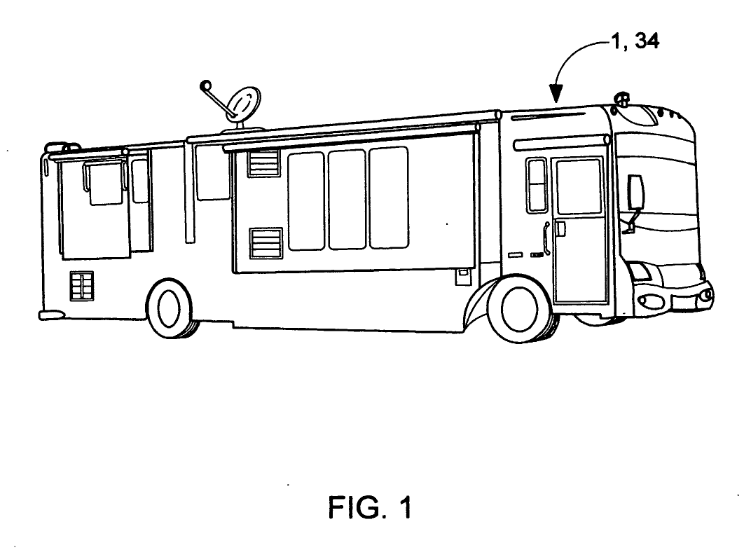

FIG. 1 displays an exterior view of a typical Class A motor home or recreational vehicle (RV) which may readily be customized, during the assembly line process, into a Mobile Grooming Vehicle. The inventive concept presented herein may be exercised with a variety of sizes and capacities of recreational vehicles. It is more economically efficient to contract with at least one manufacturer of recreational vehicles for an arrangement whereby a motor coach is purchased in advance at a stage of the assembly line process where only the frame, skin covering, and chassis of the vehicle are in place. At this point it is practical to equip the contracted-for vehicle with the furnishings, plumbing, and equipment specially required for the Mobile Grooming Vehicle.

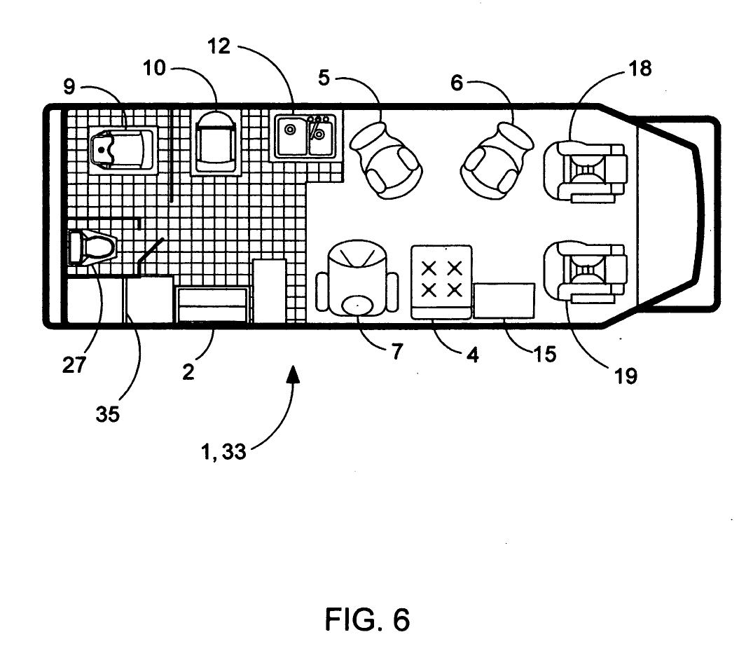

In the process of selecting franchisees for this business concept, circumstances may occasionally dictate that a smaller-sized RV be utilized in conducting the mobile hair grooming business. This may be the case where a single-operator franchisee elects to operate his/her franchise in a limited geographical area primarily for residential servicing of upscale clientele. For business profiles of this type, the franchisee may be encouraged to purchase a “C-Class” motor coach, a typical floor plan of which is illustrated in FIG. 6. The C Class MGV includes two barber chairs 5, 6, a hair stylist's chair 10, and a shampoo station 9.

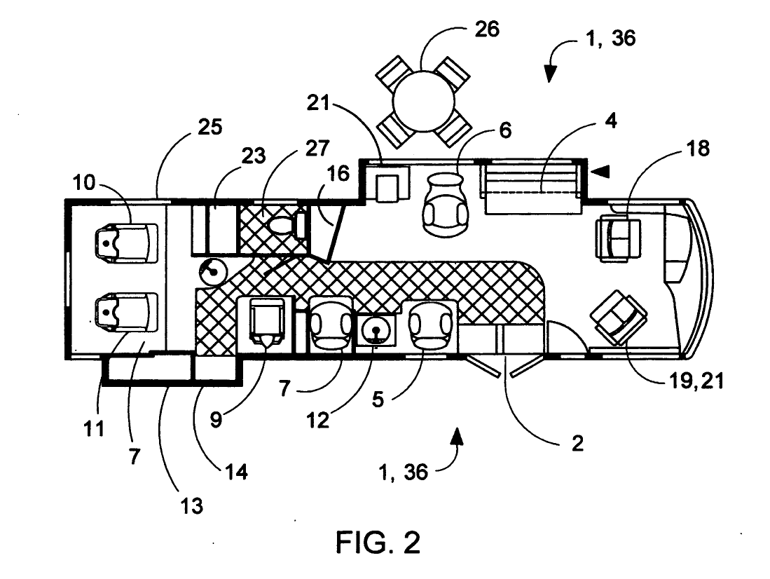

In referring to FIG. 2, the general interior floor plan of a typical medium-to-large size Class A MGV 1, 34 is displayed. The larger size MGV 1 is capable of offering multiple services, complementary to hair grooming. Such services may also include manicure 21, pedicure 19, facials, and a masseuse.

Regardless of which size vehicle is operated as an MGV, the service begins as the MGV approaches the work location. Once the driver 18 has guided the MGV 1 to the customer's location, or a designated parking area, the vehicle is configured for receiving clients. A customer boards the vehicle through the entry door 2. In the event that all barber and hair stylist stations are occupied at a worksite, newly-arriving customers may wait in customer seats 4 within the lounge area 3.

The presentation in FIG. 2 shows provisions for multiple barbers staffing the vehicle, as illustrated by a first barber chair 5 and a second barber chair 6. Further, the embodiment displayed in FIG. 2 is equipped with a first stylist's chair 7 and a second stylist's chair 8. A shampoo station 9 is floor-mounted and contains plumbing lines for the supply of hot and cold water and also lines for routing of waste water to the exteriorly-mounted grey water tank 32. A first hair dryer 10 and a second hair dryer 11 are mounted in the rearmost section of the MVG 1.

A sanitizing sink 12 is mounted on a counter to facilitate equipment cleansing and personal hand cleansing for all crew members in the MVG 1, as necessary. Space is provided for an equipment cabinet 13, product storage cabinet 14, linens storage 15, and janitorial storage 23. Where the multiple-purpose MGV is utilized, as depicted in FIG. 2, outside customer seating 26 is provided to supplement the customer lounge and seating area 4. Depending on the clientele at the MVG's location, either of the barber's chairs 5, 6, may also function as a hair stylist's station 7, and the converse is also true.

Standard equipment on all sizes of MGV include air conditioning, FM/AM radio, wide-screen television coupled to a satellite receiver, wi-fi wiring, telephone. Additional features include Ground Proximity System (GPS) for mapping and site location directions, Radio Frequency Identifier (RFI), internal security cameras The basic operational strategy of the inventive concept is based on essentially four basic business profiles, or scenarios for attracting and servicing clientele. These profiles are described as “Profile A,” a pre-planned location, MGV positioning stemming from advance advertising & marketing; “Profile B,” on-demand service for individual client; “Profile C,” contracted regular grooming services for a specific business or academic location; and “Profile D,” contracted-for provision of grooming services for a sporting or entertainment event.

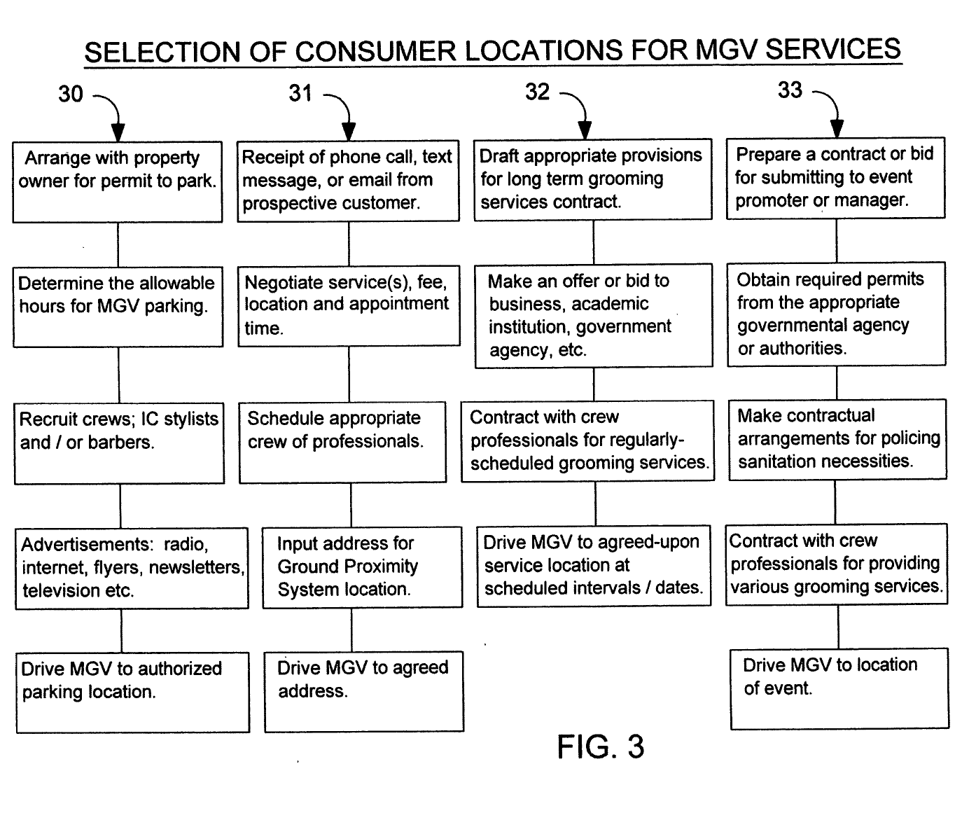

In referring to FIG.3, the four basic profiles of operation of this business method are displayed. In Profile “A” 30 is presented a random method of selecting business locales and acquiring customers. The franchise owner of the MGV arranges in advance for parking permits or permission from a site owner to allow parking of the vehicle at a specific geographic location for a set period of time. A crew or crews of barber and/or stylists is scheduled for manning the MGV for the duration of the parking permit. Media advertisements are then promulgated in advance of parking the vehicle at the permitted location and afterwards, hair grooming operations are initiated at the site.

FIG. 3 also presents Profile “B” 31 of business operations wherein, pursuant to long-term internet advertising, yellow pages advertising and regularly-placed media advertisements, the availability of the MGV services have received a substantial amount of public exposure. As a result, spontaneous customer requests for hair grooming services may be received by the franchise owner. Upon receipt of a phone call, text message, or email from a prospective customer, the franchise operator will ensure that the appropriate hair grooming professional is immediately available for providing the requested services. Thereafter, an arrangement for the price of the requested service(s), a time, and location is mutually agreed upon, which location may be the residence of the prospective customer. The MGV is then dispatched to the agreed upon location where the hair grooming services are rendered.

Next, FIG. 3 depicts Profile “C” 32 of the mobile hair grooming business. With this method, the franchise operator drafts a contractual proposal for the providing of hair grooming services to a permanently located business, academic institution, government facility, or similar entity that regularly experiences a relatively large assemblage of persons. Once the contract is awarded, the franchise operator prepares a long-term schedule for the availability of hair grooming professionals to work onboard the MGV for the entire duration of the negotiated contract.

Profile “D” 33 of this inventive concept is also presented in FIG. 3, wherein the franchise operator may submit an application for the providing of hair grooming services at the venue of an upcoming public event, typically sports events, trade shows, or entertainment productions. The necessary permits and authorizations from appropriate public agencies or other authorities must also be obtained prior to the MGV being utilized in this business profile.

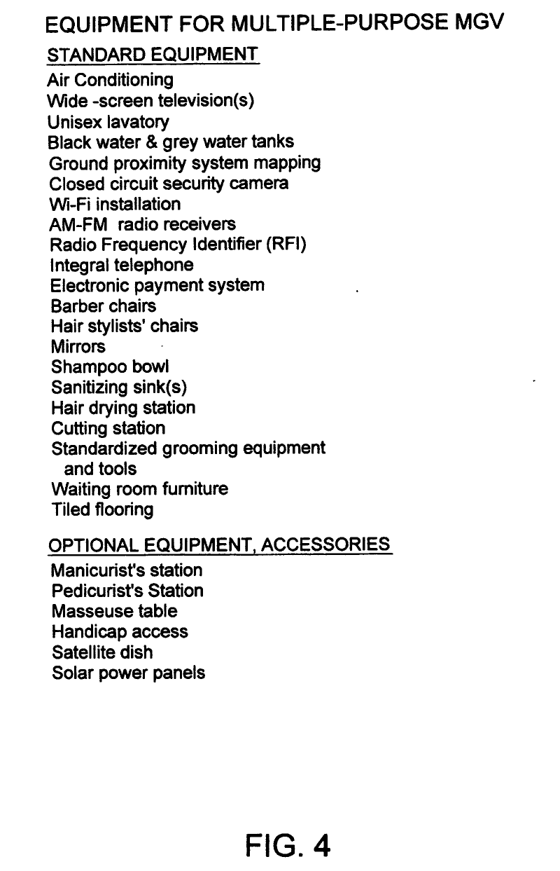

FIG. 4 presents a listing of standard and optional equipment and accessories which franchisees may elect to include when consummating their licensing, or franchise agreement.

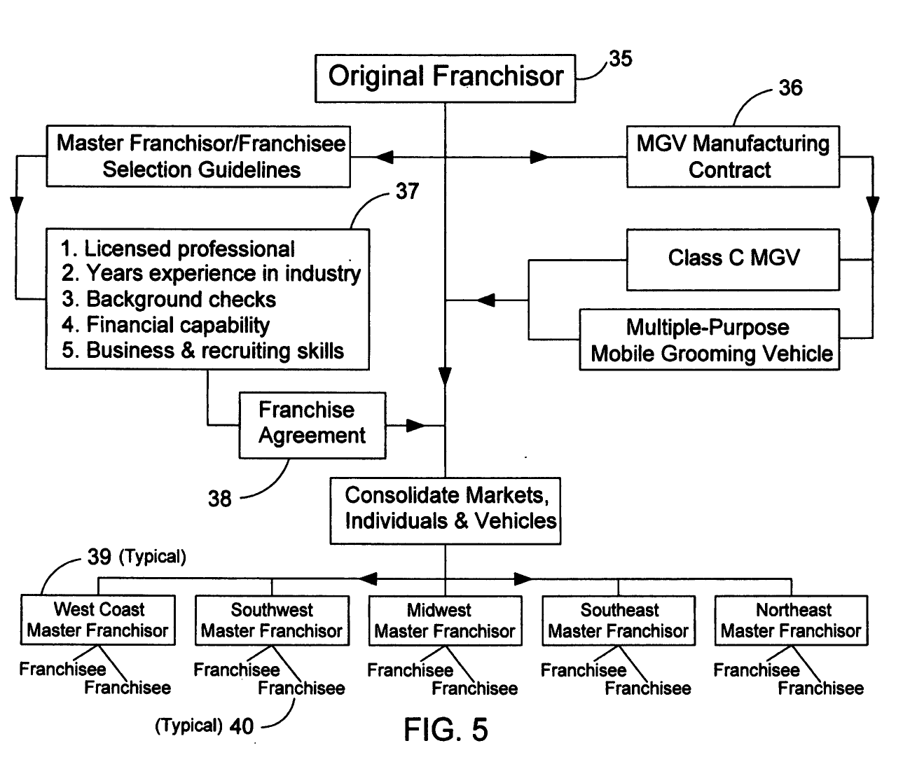

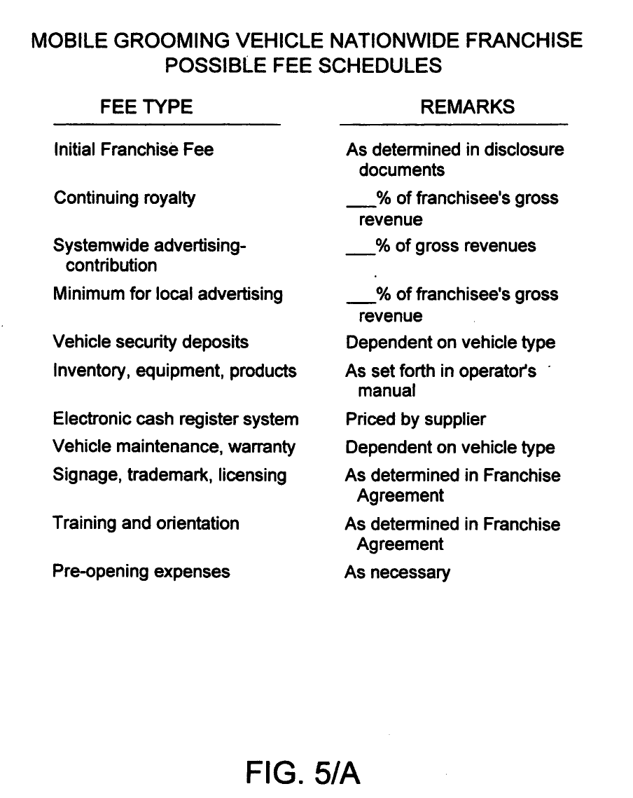

FIG. 5 sets forth the outline of a plan to incorporate the inventive concept within the arrangement of a nationwide franchising organization. An “Original Franchisor” 35 initiates the legal requirements for a franchised business, including compliance with the 2007 revision of the Federal Trade Commission (FTC) Rule, codified as 16 CFR Part 436. The original franchisor 35 next arranges for the detailed manufacturing contract 36, which will include assembly procedures and equipment for at least three different-sized recreational vehicles as produced by a selected manufacturer. The initial MGV's deriving from such assembly profile will be placed into at least one market to establish an efficient operational venture.

Concurrent with such vehicle break-in, the original franchisor will have begun the process of interviewing candidates pursuant to the Franchisee Selection Guidelines 37. The Original Franchisor 35 must then consolidate the interviewed candidates, the available MGV's, and the market in which the franchisee candidates reside. An appropriate disclosure document and Franchise Agreement 38 will be entered into, in the preferred embodiment of the invention, by selected Master Franchisors 39. However, there may be instances where the Original Franchisor 35 will enter directly into a Franchise Agreement 38 with a franchisee, who may later develop his/her business into that of a Master Franchisor 39.

FIG. 5A depicts a possible fee schedule to which Master Franchisors 39 and franchisees may be expected to comply with during the term of their Franchise Agreement 38.

The reader must realize that the vehicles and floor plans presented herein are not intended to be precise renditions or floor plan layouts for the inventive concept disclosed. The make, manufacturer, and interior arrangement of any MGV will vary as business needs dictate. Thus, the illustrations and Figures herein are not to be construed as placing limitations on the inventive concept. It is also recognized that persons knowledgeable and skilled in the hair grooming industry have the capability to design or engage in similar or comparable business enterprises featuring other embodiments of this inventive concept. However, all such enterprises, variations, alterations, or modifications are entirely conceivable as being within the intent and scope of the present inventive concept.

What is claimed is:

1. A motorized vehicle specially designed, and interiorly equipped and furnished to enable the providing of hair and personal grooming services at various locations, with a plurality of such vehicles capable of providing said services on a standardized nationwide basis; said vehicle having minimally, at least two barber chairs, one floor-mounted shampoo bowl, one hair stylist's chair, one floor-mounted hair dryer, one sanitizing sink, one satellite television receiving dish, and a sufficient variety of professional accessories and supplies required for providing said grooming services; said vehicle further varying in size, weight, and interior design in accordance with the volume of grooming services projected.

2. A method for operating a business network of hair and personal grooming services by means of the utilization of a plurality of motorized vehicles specially designed and interiorly equipped and furnished to enable the providing of said services, at various locations; said vehicles having minimally, two barber chairs, one floor-mounted shampoo bowl, one hair stylist's chair, one floor-mounted hair dryer, one sanitizing sink, one satellite television receiving dish, and a sufficient variety of professional accessories and supplies required for providing said services; said vehicles further varying in size, weight, and interior design in accordance with the volume of grooming services projected, comprising the steps of
a) contracting with a recreational vehicle manufacturer to construct a plurality of vehicles specially designed and interiorly equipped to provide personal grooming services;
b) seeking, interviewing, and qualifying potential owner/operators of said vehicles, based on network-wide, standardized personal grooming procedures;
c) devising a manual of standardized operating procedures, grooming techniques, and marketing systems applicable to said grooming services;
d) acquiring the necessary operating privileges and certifications as required by governmental entities in the geographic territory where such services are sought to be provided; and
e) licensing to said owner/operators the right to lease or purchase one or more of said vehicles, for the purpose of operating a mobile hair and personal grooming services business within said network.

3. A method for operating a nation-wide business franchise specializing in hair and personal grooming services by means of the utilization of a plurality of motorized vehicles specially designed and interiorly equipped and furnished to enable the providing, at various locations, of said services, comprising the steps of
a) contracting with a recreational vehicle manufacturer to construct a plurality of vehicles as set forth in claim 2;
b) drafting disclosure documents, franchise agreements, and other materials and information as required by applicable state and federal franchising laws;
c) seeking, interviewing, and qualifying potential franchisees as owners and/or operators of said vehicles, based on a standardized nation-wide franchise agreement;
d) devising a manual of standardized operating procedures, grooming techniques, and marketing systems applicable to said services;
e) acquiring the necessary operating privileges and certifications as required by governmental entities in the geographic territory where such services are sought to be provided; and
f) licensing to said franchisees the right to lease or purchase one or more of said vehicles, for the purpose of operating a mobile hair and personal grooming business based on said franchise agreement.

4. A method for operating a nation-wide franchise business specializing in personal and hair grooming services by means of the utilization of a plurality of motorized vehicles specialized equipped for the rendering of said services, comprising the steps of
a) contracting with a recreational vehicle manufacturer to construct a plurality of said vehicles, such vehicles as set forth in either claim 1 or claim 2, above;
b) drafting disclosure documents, franchise agreements, and other materials and information as required by applicable state and federal franchising laws;
c) seeking, interviewing, and qualifying individuals as potential franchisees and owner/operators of said vehicles, based on a standardized nation-wide franchise agreement;
d) devising a manual of standardized operating procedures, grooming techniques, and marketing systems applicable to said services;
e) acquiring the necessary operating privileges and certifications as required by governmental entities in the geographic territory where such services are sought to be provided; and
f) licensing to said franchisees the right to lease or purchase one or more of said vehicles, for the purpose of operating a mobile hair and personal grooming business based on said franchise agreement.

5. A method for operating a mobile hair and personal grooming service in the form of a nation-wide franchised business, comprising the steps of:
a) providing to franchisees, the right and license to purchase a motorized vehicle from a specific manufacturer, said motorized vehicle specially designed, and interiorly equipped and furnished to enable the providing of hair and personal grooming services; said vehicle having minimally, at least two barber chairs, one floor-mounted shampoo bowl, one hair stylist's chair, a floor-mounted hair dryer, a sanitizing sink, one satellite television receiving dish, and a sufficient variety of professional accessories and supplies required for the rendering of said grooming services;
b) drafting disclosure documents, franchise agreements, and other materials and information as required by applicable state and federal franchising laws;
c) providing each franchisee a standardized manual of hair styling techniques, personal grooming systems, barbering procedures, and vehicle operational methods;
d) providing each franchisee with discounted access to specific products and supplies as designated by franchisor;
e) providing each franchisee with standardized accounting, personnel management, and cash management procedures;
f) providing each franchisee with access to logos, trademarks, media publicity, and the use of advertising materials containing references to the nationally-recognized provider of hair grooming services; and
g) collecting from each franchisee periodic royalty payments and other fees in accordance with the franchise agreement.
